(19) United States
(12) Patent Application Publication
(10) Pub. No.: US 2016/0219793 A1
(43) Pub. Date: Aug. 4, 2016

(54) High-torsion electric pruning shears

(71) Applicant: Ma Xianpeng, Xia Men (CN)

(72) Inventor: Ma Xianpeng, Xia Men (CN)

(21) Appl. No.: 14/612,340

(22) Filed: Feb. 3, 2015

(51) Int. Cl. A01G 3/037

(52) U.S. Cl. CPC A01G 3/037

(57) ABSTRACT

The invention discloses a pair of high-torsion electric pruning shears, which include an enclosure (1), wherein a direct current brushless motor 9 is fixedly mounted in the enclosure (1); a socket (8) is connected to a rear end of the direct current brushless motor (9); a front end of the direct current brushless motor (9) is connected with a ball screw (7) through a gearbox (10); a trigger (2) is fixedly mounted on a lower surface of the enclosure (1); a sensing unit is also arranged in the enclosure (1) over the trigger (2); and a shear part driven by the ball screw (7) is mounted at the front end of the enclosure (1). The high-torsion electric pruning shears have the beneficial effects of simple structure and high practicability.

### TECHNICAL FIELD OF THE INVENTION

The invention relates to pruning shears, in particular to high-torsion electric pruning shears.

### BACKGROUND OF THE INVENTION

The torsion of knife edges of most of pruning shears on the current market is increased by virtue of transmission gearboxes, only branches with diameters of 1-30MM can be sheared at ordinary times due to the limitation of the torsion of the transmission gearboxes, and in a pruning process, a radian problem of a fixed blade easily causes the phenomenon of branch skipping. In addition, when blades of the conventional pruning shears are replaced, a housing of the pruning shears is usually required to be completely disassembled, which causes great influence on the operational performance of the pruning shears. Dust usually enters a conventional trigger easily, which causes the phenomenon of a failure of the trigger in a using process and greatly influences the service life of the pruning shears.

### SUMMARY OF THE INVENTION

In order to solve the above problem, the invention designs a pair of high-torsion electric pruning shears.

The first purpose of the invention is to solve the problem of low torsion of conventional pruning shears and provide a pair of high-torsion electric pruning shears. The conventional pruning shears with low torsion usually can shear branches with diameters of 1-30MM only, while the high-torsion electric pruning shears of the invention can shear branches with diameters of 1-40MM.

The second purpose of the invention is to solve a blade replacement problem. Blades of the conventional pruning shears are troublesome in replacement, and can usually be replaced only by completely disassembling an enclosure, which always causes damage to a circuit structure easily. However, a movable blade and a fixed blade of the high-torsion electric pruning shears of the invention can be replaced only by loosening respective dowel clamping pieces and locking pieces, so that the blades can be conveniently and rapidly replaced when getting blunt.

The third purpose of the invention is to solve the problem that a conventional trigger is non-dustproof. The trigger of the conventional pruning shears is usually connected with a circuit board, while a trigger of the high-torsion electric pruning shears of the invention is separated from a circuit board rather than being connected with the circuit board, so that the problem that the trigger is non-dustproof is solved.

In order to achieve the above purposes, the technical solution of the invention is as follows: a pair of high-torsion electric pruning shears include an enclosure 1, wherein a direct current brushless motor 9 is fixedly mounted in the enclosure 1; a socket 8 is connected to a rear end of the direct current brushless motor 9; a front end of the direct current brushless motor 9 is connected with a ball screw 7 through a gearbox 10; a trigger 2 is fixedly mounted on a lower surface of the enclosure 1; a sensing unit is also arranged in the enclosure 1 over the trigger 2; and a shear part driven by the ball screw 7 is mounted at the front end of the enclosure 1.

The shear part is a shear structure formed by connecting a fixed blade 5 which is fixed at the front end of the enclosure 1 with a movable blade 6 of which one end is connected with the ball screw 7 through a fixed blade threaded rod 20, and a fixing part for fixing and locking the fixed blade threaded rod 20 is arranged on the fixed blade 5.

The fixing part consists of three parts, i.e. a gear nut 4 screwed on the fixed blade threaded rod 20, a locking piece 3 joined with the gear nut 4 and a locking piece nut 18 for fixing the locking piece 3 on the fixed blade 5.

The fixed blade 5 is fixed at the front end of the enclosure 1 through a nut 21, and the movable blade 6 is movably connected with a telescopic part of the ball screw 7 through a movable blade dowel 19 and a dowel clamping piece 17 for fixing the movable blade dowel 19.

The sensing unit consists of three parts, i.e. a closing Hall sensing head 12, a switching Hall sensing head 16 and an opening Hall sensing head 11, wherein the closing Hall sensing head 12 is close to the front end of the enclosure 1, the opening Hall sensing head 11 is close to the rear end of the enclosure 1, and the switching Hall sensing head 16 is positioned between the closing Hall sensing head 12 and the opening Hall sensing head 11.

A switching magnet 15 is arranged on the trigger 2, and a position of the switching magnet 15 corresponds to that of the switching Hall sensing head 16.

An upper magnet 13 and a lower magnet 14 are arranged at upper and lower ends of the ball screw 7 respectively, and positions of the upper magnet 13 and the lower magnet 14 correspond to each other to form a stable magnetic field.

The high-torsion electric pruning shears manufactured by the technical scheme of the invention is reasonable in structural design and high in practicability; with the adoption of the direct current brushless motor, higher torsion can be provided, and the pruning shears have the advantages of stronger shear force, convenience in the replacement of the blades and dust tightness; with the adoption of the direct current brushless motor, higher torsion can be provided, and the pruning shears are longer in service life; in addition, an overload protection program is set in a circuit board program, and automatically stops the direct current brushless motor when a harder object is sheared by the movable blade, so that the pruning shears are effectively protected from being burnt out.

### BRIEF DESCRIPTION OF THE DRAWINGS

FIG. 1 is an overall structure diagram of high-torsion electric pruning shears according to the invention;

FIG. 2 is an overall section view of high-torsion electric pruning shears according to the invention; and

FIG. 3 is a section view of an enclosure according to the invention.

In the drawings, 1 enclosure, 2 trigger, 3 locking piece, 4 gear nut, 5 fixed blade, 6 movable blade, 7 ball screw, 8 socket, 9 direct current brushless motor, 10 gearbox, 11 opening Hall sensing head, 12 closing Hall sensing head, 13 upper magnet, 14 lower magnet, 15 switching magnet, 16 switching Hall sensing head, 17 dowel clamping piece, 18 locking piece nut, 19 movable blade dowel, 20 fixed blade threaded rod and 21 trigger spring.

### DETAILED DESCRIPTION OF THE EMBODIMENTS

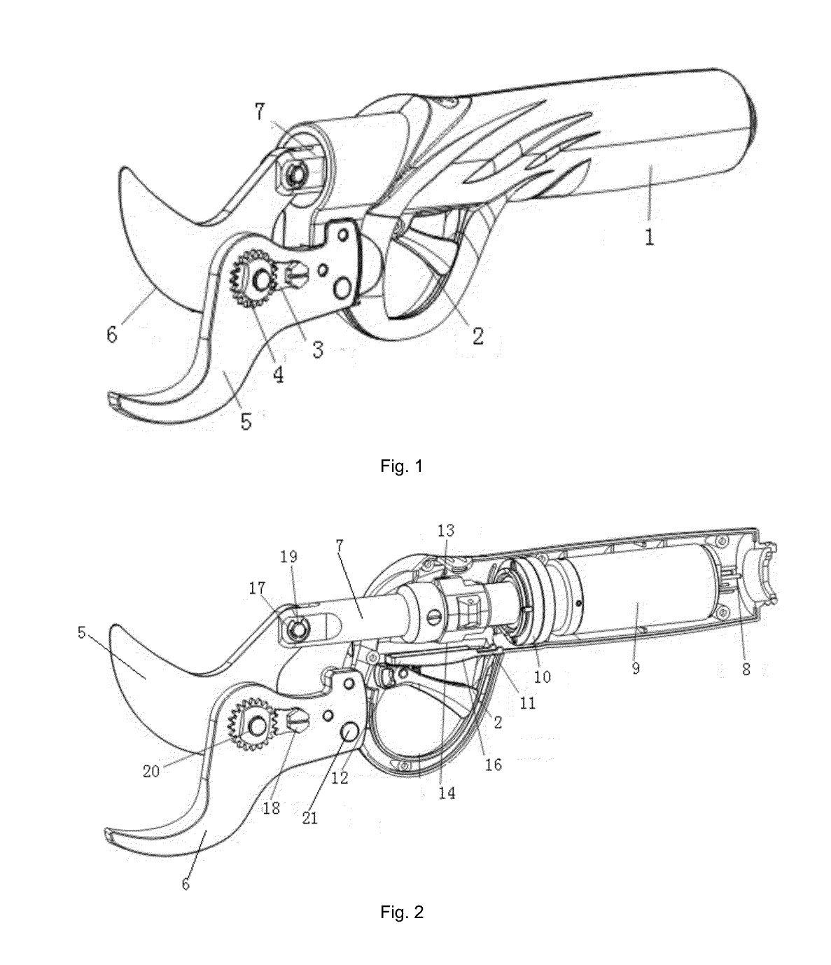

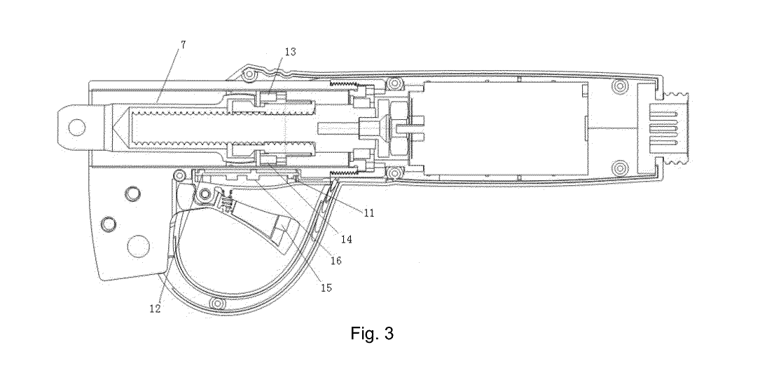

The invention is specifically described below with reference to the drawings, and as shown in FIG. 1-3, a pair of high-torsion electric pruning shears includes an enclosure 1, wherein a direct current brushless motor 9 is fixedly mounted in the enclosure 1; a socket 8 is connected to a rear end of the direct current brushless motor 9; a front end of the direct current brushless motor 9 is connected with a ball screw 7 through a gearbox 10; a trigger 2 is fixedly mounted on a lower surface of the enclosure 1; a sensing unit is also arranged in the enclosure 1 over the trigger 2; a shear part driven by the ball screw 7 is mounted at the front end of the enclosure 1; the shear part is a shear structure formed by connecting a fixed blade 5 which is fixed at the front end of the enclosure 1 with a movable blade 6 of which one end is connected with the ball screw 7 through a fixed blade threaded rod 20, a fixing part for fixing and locking the fixed blade threaded rod 20 is arranged on the fixed blade 5; the fixing part consists of three parts, i.e. a gear nut 4 screwed on the fixed blade threaded rod 20, a locking piece 3 joined with the gear nut 4 and a locking piece nut 18 for fixing the locking piece 3 on the fixed blade 5; the fixed blade 5 is fixed at the front end of the enclosure 1 through a nut 21, and the movable blade 6 is movably connected with a telescopic part of the ball screw 7 through a movable blade dowel 19 and a dowel clamping piece 17 for fixing the movable blade dowel 19; the sensing unit consists of three parts, i.e. a closing Hall sensing head 12, a switching Hall sensing head 16 and an opening Hall sensing head 11, the closing Hall sensing head 12 is close to the front end of the enclosure 1, the opening Hall sensing head 11 is close to the rear end of the enclosure 1, and the switching Hall sensing head 16 is positioned between the closing Hall sensing head 12 and the opening Hall sensing head 11; a switching magnet 15 is arranged on the trigger 2, and a position of the switching magnet 15 corresponds to that of the switching Hall sensing head 16; and an upper magnet 13 and a lower magnet 14 are arranged at upper and lower ends of the ball screw 7 respectively, and positions of the upper magnet 13 and the lower magnet 14 correspond to each other to form a stable magnetic field.

Specific implementation modes of the high-torsion electric pruning shears of the invention are as follows:

### 1. Shearing Process

After the socket is connected with a power supply through an electric wire, an operator pulls the trigger in which the switching magnet is mounted, and when the trigger is pulled and pressed downwards to the lowest position, the switching Hall sensing head senses a magnetic field of the switching magnet, and the direct current brushless motor is energized and driven to work. The direct current brushless motor is connected with the ball screw through the gearbox, and by the speed changing of the gearbox, the torsion of the ball screw is increased, the ball screw is further driven to rotate so as to promote the telescopic part of the ball screw to horizontally extend out of the enclosure, and meanwhile, the movable blade connected with the ball screw is driven by the ball screw to rotate around the fixed blade threaded rod and be matched with the fixed blade for shearing movement. When the magnetic field which is sensed by the closing Hall sensing head and formed by the upper and lower magnets of the ball screw reaches certain intensity, the direct current brushless motor stops working, and the movable blade and the fixed blade are switched from an original open state to completely closed state, and are matched to finish shearing branches. In such a way, a periodic shearing movement is finished.

### 2. Opening Process

After the movable blade is matched with the fixed blade, the trigger is released, the trigger is pressed downwards again, then the direct current brushless motor rotates backwards, the ball screw is retracted so as to drive the movable blade and the fixed blade to be opened, and when the magnetic field which is sensed by the opening Hall sensing head and formed by the upper and lower magnets reaches certain intensity, the direct current brushless motor stops rotating, and then the ball screw finishes the opening movement of the movable blade. In such a way, a periodic opening movement is finished.

### 3. Replacement of the Blades

When the movable blade is abraded and blunted, the dowel clamping piece can be taken out, and then the movable blade dowel is pulled out, so that the movable blade is loosened, and can be taken out for replacement.

When the fixed blade is abraded and blunted, the locking piece nut and the nut on the enclosure can be unscrewed, the locking piece is loosened, the gear nut is further loosened, and then the fixed blade is taken out of the fixed blade threaded rod for replacement. By such a structural design, the movable blade and the fixed blade can be conveniently replaced, more time is saved, and the efficiency is improved. In addition, the movable blade and the fixed blade are both made of high-speed steel, so that strength is greatly strengthened, and the movable blade and the fixed blade are difficult to abrade.

### 4. Design of the Fixed Blade

A 15-degree radian design is adopted for the fixed blade, so that the phenomenon of branch skipping when the movable blade shears branches can be prevented.

### 5. Dust-Proofing of the Trigger

In the technical solution, the trigger is not connected with a circuit, and the circuit is switched on and off by virtue of the switching magnet on the trigger, so that the trigger is isolated from the circuit board, and the phenomenon that dust or impurities enter the circuit board to cause a switching failure is prevented.

### 6. Protection Design

With the adoption of the direct current brushless motor, high torsion can be provided, and the pruning shears are longer in service life. In addition, an overload protection program is set in a circuit board program, and automatically stops the direct current brushless motor when a harder object is sheared by the movable blade, so that the pruning shears are effectively protected from being burnt out.

The technical solution is only the preferred technical solution of the invention, and some variations probably made over some parts in the technical solution by those skilled in the art reflect the principle of the invention, and fall within the scope of protection of the invention.

1. High-torsion electric pruning shears, comprising an enclosure (1), wherein a direct current brushless motor (9) is fixedly mounted in the enclosure (1); a socket (8) is connected to a rear end of the direct current brushless motor (9); a front end of the direct current brushless motor (9) is connected with a ball screw (7) through a gearbox (10); a trigger (2) is fixedly mounted on a lower surface of the enclosure (1); a sensing unit is also arranged in the enclosure (1) over the trigger (2); and a shear part driven by the ball screw (7) is mounted at the front end of the enclosure (1).

2. The high-torsion electric pruning shears according to claim 1, wherein the shear part is a shear structure formed by connecting a fixed blade (5) which is fixed at the front end of the enclosure (1) with a movable blade (6) of which one end is connected with the ball screw (7) through a fixed blade threaded rod (20), and a fixing part for fixing and locking the fixed blade threaded rod (20) is arranged on the fixed blade (5).

3. The high-torsion electric pruning shears according to claim 2, wherein the fixing part consists of three parts, i.e. a gear nut (4) screwed on the fixed blade threaded rod (20), a locking piece (3) joined with the gear nut (4) and a locking piece nut (18) for fixing the locking piece (3) on the fixed blade (5).

4. The high-torsion electric pruning shears according to claim 2, wherein the fixed blade (5) is fixed at the front end of the enclosure (1) through a nut (21), and the movable blade (6) is movably connected with a telescopic part of the ball screw (7) through a movable blade dowel (19) and a dowel clamping piece (17) for fixing the movable blade (19).

5. The high-torsion electric pruning shears according to claim 1, wherein the sensing unit consists of three parts, i.e. a closing Hall sensing head (12), a switching Hall sensing head (16) and an opening Hall sensing head (11), the closing Hall sensing head (12) is close to the front end of the enclosure (1), the opening Hall sensing head (11) is close to the rear end of the enclosure (11), and the switching Hall sensing head (16) is positioned between the closing Hall sensing head (12) and the opening Hall sensing head (11).

6. The high-torsion electric pruning shears according to claim 1, wherein a switching magnet (15) is arranged on the trigger (2), and a position of the switching magnet (15) corresponds to that of the switching Hall sensing head (16).

7. The high-torsion electric pruning shears according to claim 1, wherein an upper magnet (13) and a lower magnet (14) are arranged at upper and lower ends of the ball screw (7) respectively, and positions of the upper magnet (13) and the lower magnet (14) correspond to each other to form a stable magnetic field.
